(19) United States
(12) Patent Application Publication
(10) Pub. No.: US 2016/0092913 A1
(43) Pub. Date: Mar. 31, 2016

(54) TIME INTERVAL-BASED STATISTICALLY-INFERRED RESPONSE ATTRIBUTIONS

(71) Applicant: International Business Machines Corporation, Armonk, NY (US)

(72) Inventors: Robert H. Crites, Mechanicsburg, PA (US); Ruby L. Kennedy, Bedford, MA (US)

(21) Appl. No.: 14/723,783

(22) Filed: May 28, 2015

Related U.S. Application Data
(63) Continuation of application No. 14/502,161, filed on Sep. 30, 2014.

(51) Int. Cl. G06Q 30/02

(52) U.S. Cl. CPC G06Q 30/0246

(57) ABSTRACT

A time interval-based stimulus is created based upon a statistically-inferred time interval-based response rate. The time interval-based stimulus accounts over time for a proportion of responses that occur without being attributable to other stimuli. A response is retrieved. A time-interval response attribution value is calculated using the time interval-based stimulus and the response by applying a combination of a first response rate model and a second time delay model that weights output of the first response rate model based upon a continuous range of time delays between a minimum and maximum difference in time that separate the time interval-based stimulus and the response.

### BACKGROUND

The present invention relates to marketing response attribution to marketing contacts/channels. More particularly, the present invention relates to time interval-based statistically-inferred response attributions.

Marketing of products and services to potential customers may be performed by many different marketing channels, such as advertisements on websites, email, and telephone. When consumers respond to a marketing contact from one of the marketing channels and purchase an advertised product or service, the advertisement and the respective marketing contact may be considered successful at converting the potential customer to an actual customer.

### BRIEF SUMMARY

A computer-implemented method includes creating, by a processor, a time interval-based stimulus based upon a statistically-inferred time interval-based response rate, where the time interval-based stimulus accounts over time for a proportion of responses that occur without being attributable to other stimuli; retrieving a response; and calculating, using the time interval-based stimulus and the response, a time-interval response attribution value, where the time-interval response attribution value is calculated by applying a combination of a first response rate model and a second time delay model that weights output of the first response rate model based upon a continuous range of time delays between a minimum and maximum difference in time that separate the time interval-based stimulus and the response.

A system includes a memory; and a processor programmed to: create, within the memory, a time interval-based stimulus based upon a statistically-inferred time interval-based response rate, where the time interval-based stimulus accounts over time for a proportion of responses that occur without being attributable to other stimuli; retrieve a response; and calculate, using the time interval-based stimulus and the response, a time-interval response attribution value, where the time-interval response attribution value is calculated by applying a combination of a first response rate model and a second time delay model that weights output of the first response rate model based upon a continuous range of time delays between a minimum and maximum difference in time that separate the time interval-based stimulus and the response.

A computer program product includes a computer readable storage medium having computer readable program code embodied therewith, where the computer readable program code when executed on a computer causes the computer to: create a time interval-based stimulus based upon a statistically-inferred time interval-based response rate, where the time interval-based stimulus accounts over time for a proportion of responses that occur without being attributable to other stimuli; retrieve a response; and calculate, using the time interval-based stimulus and the response, a time-interval response attribution value, where the time-interval response attribution value is calculated by applying a combination of a first response rate model and a second time delay model that weights output of the first response rate model based upon a continuous range of time delays between a minimum and maximum difference in time that separate the time interval-based stimulus and the response.

### BRIEF DESCRIPTION OF THE SEVERAL VIEWS OF THE DRAWINGS

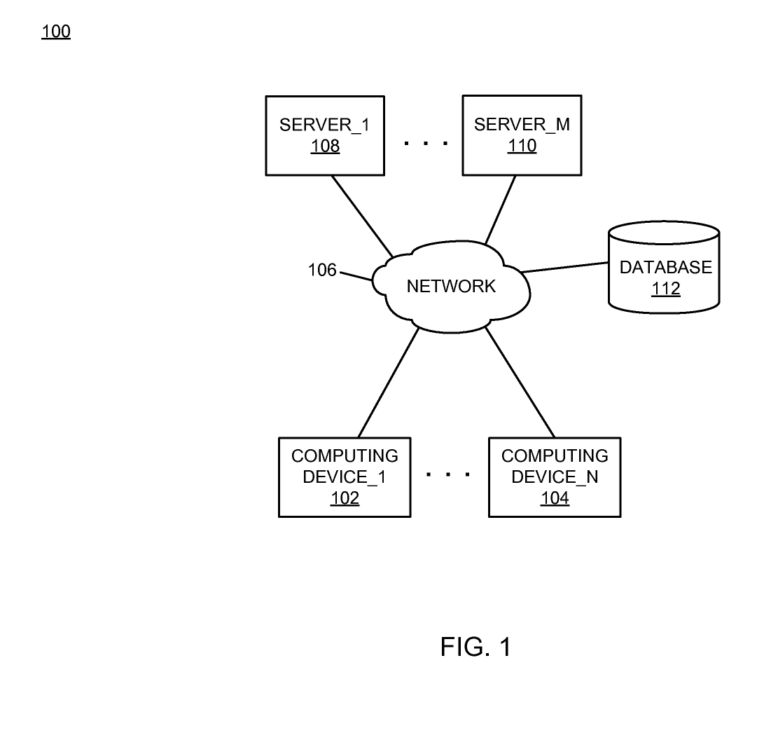

Figure (FIG. 1 is a block diagram of an example of an implementation of a system for time interval-based statistically-inferred response attributions according to an embodiment of the present subject matter;

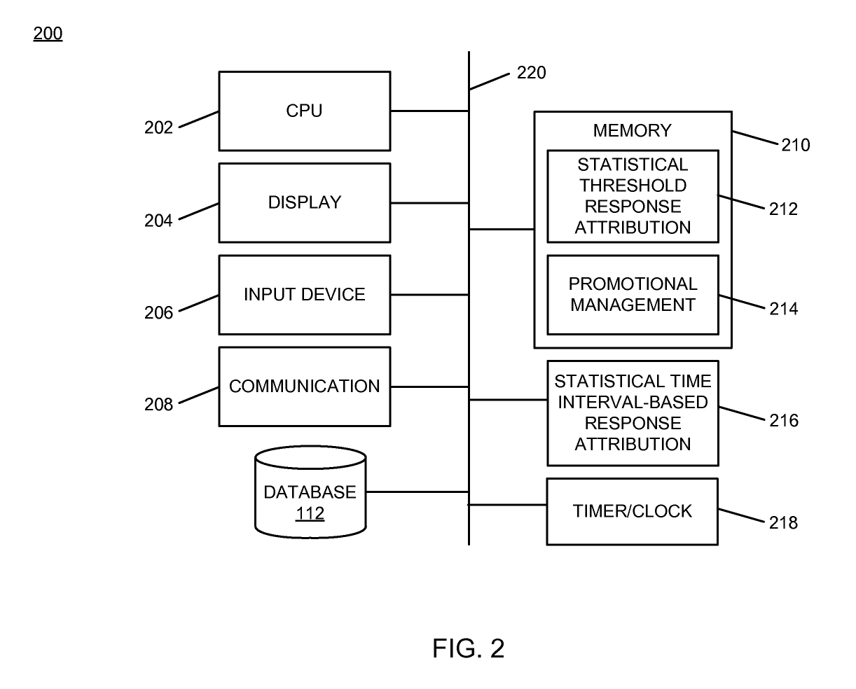

Figure (FIG. 2 is a block diagram of an example of an implementation of a core processing module capable of performing time interval-based statistically-inferred response attributions according to an embodiment of the present subject matter;

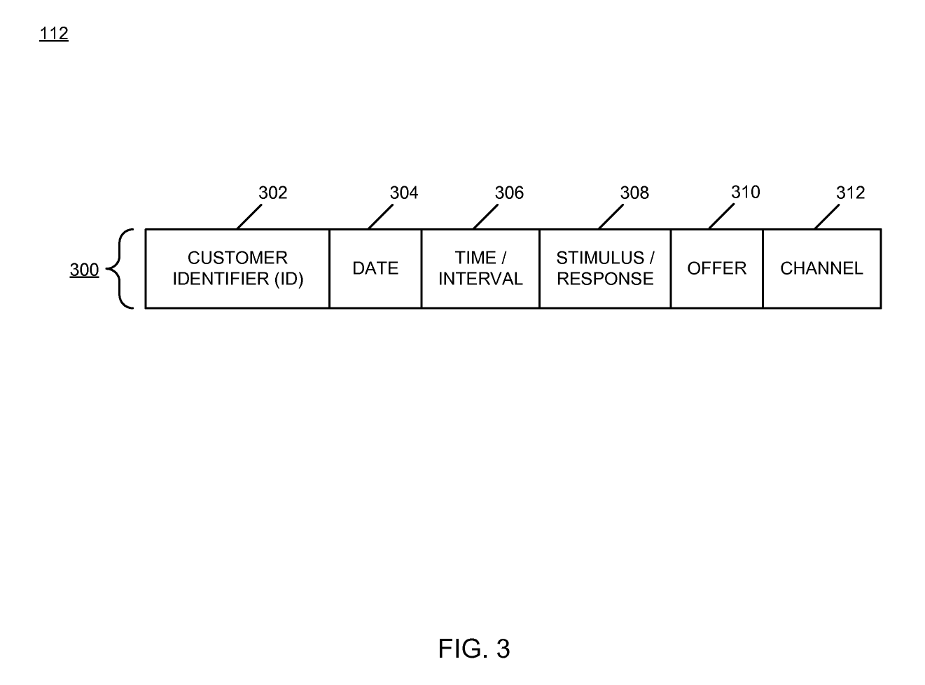

Figure (FIG. 3 is a diagram of an example of an implementation of a customer database record stored within a database that may be used to perform the time interval-based statistically-inferred response attributions according to an embodiment of the present subject matter;

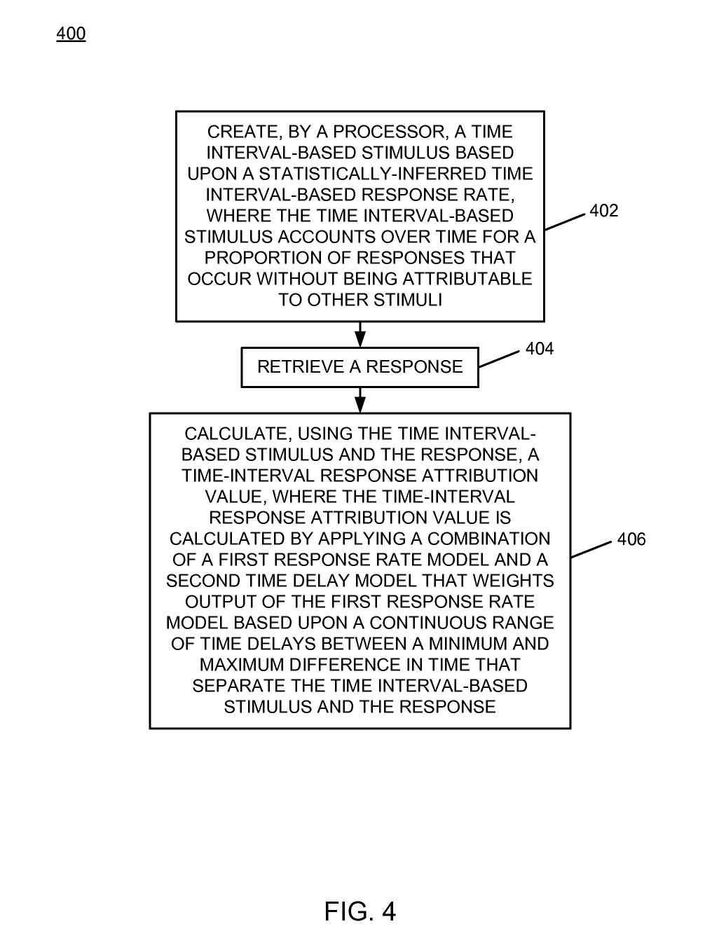

Figure (FIG. 4 is a flow chart of an example of an implementation of a process for time interval-based statistically-inferred response attributions according to an embodiment of the present subject matter; and

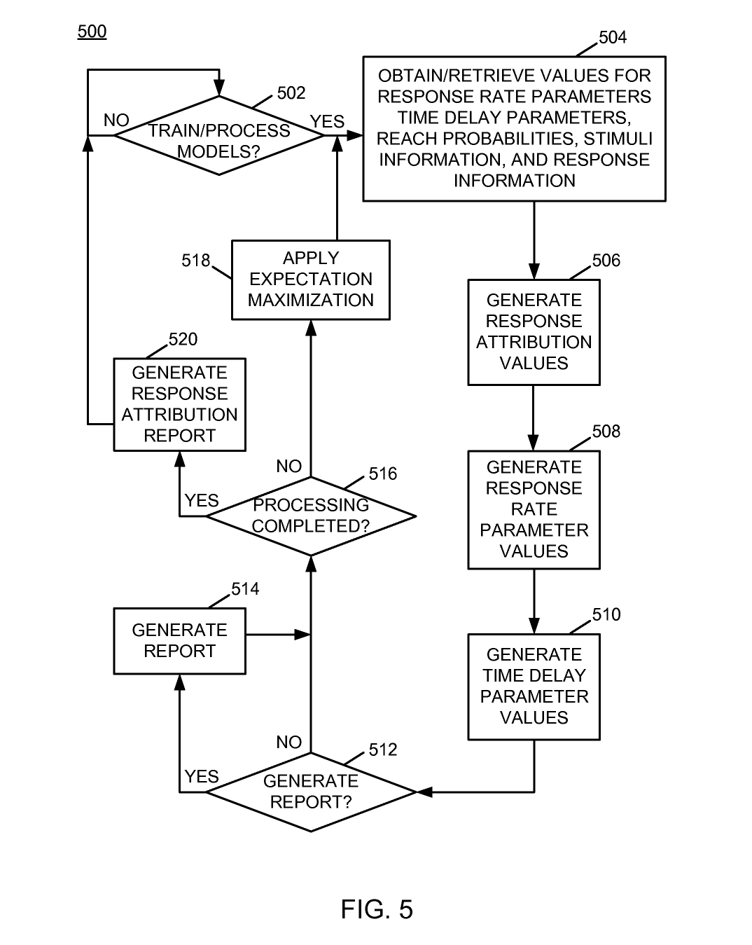

Figure (FIG. 5 is a flow chart of an example of an implementation of a process for time interval-based statistically-inferred response attributions that implements an expectation maximization (E-M) process according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides time interval-based statistically-inferred response attributions. A time interval-based stimulus is created by a processor based upon a statistically-inferred time interval-based response rate. The time interval-based stimulus accounts over time for a proportion of responses that occur without being attributable to other stimuli. A time-interval response attribution value is calculated using the time interval-based stimulus and a response. The time-interval response attribution value is calculated by applying a combination of a first response rate model and a second time delay model that weights output of the first response rate model based upon a continuous range of time delays between a minimum and maximum difference in time that separate the time interval-based stimulus and the response.

The statistically-inferred time interval-based response rate may be a statistically-inferred time-based threshold response rate or a statistically-inferred time marketing-range response rate. Where the statistically-inferred time interval-based response rate is a statistically-inferred time-based threshold response rate, a threshold stimulus is created based upon the statistically-inferred time-based threshold response rate. The threshold stimulus accounts over time for responses that occur without being caused by other preceding stimuli.

Alternatively, where the statistically-inferred time interval-based response rate is a statistically-inferred time marketing-range response rate, a marketing-range stimulus is created based upon the statistically-inferred time marketing-range response rate. The marketing-range stimulus accounts over time for responses that occur for which at least one of a confirmed contact and a confirmed time of contact is unknown.

It should be noted that the “threshold” response rate (e.g., a base or background response rate), as described herein, may occur for a given advertising entity outside of its actual marketing efforts. For example, a certain quantity of products and/or services may be purchased by consumers without direct influence from marketing campaigns, such as emails, coupons, and other forms of advertisements. This quantity of products and/or services purchased without direct influence from marketing campaigns is not accounted for using prior technologies because there were no prior means by which to determine how to form a sales attribution to these types of sales. The statistically-inferred threshold response rate described herein acts as a bias/offset for crediting attribution to different marketing channels. The threshold response rate may be applied as described herein to “point” stimuli (e.g., single event stimuli) and to “interval” stimuli (e.g., mass media or other stimuli that persist for particular durations of time). The terms “statistically-inferred threshold response rate” and “threshold response rate” are used interchangeably herein. As such, reference to either term may be utilized as convenient for a given portion of the present description. Further, the “threshold stimulus” may be created as described here based upon the threshold response rate.

Further, the terms “statistically-inferred marketing-range response rate” and “marketing-range response rate” are used interchangeably. The marketing-range response rate refers to a response rate attributable to interval-based marketing campaigns for which it cannot be determined when, or if, a particular stimulus during a marketing interval actually made contact with the respective consumer. For example, for mass media advertisements (e.g., radio, television, newspapers, etc.), a commercial advertisement may be available multiple times during a time interval, but there may be no way to determine whether the consumer actually viewed and/or heard the advertisement. Additionally, for an email campaign, it may not be possible to determine when during a time interval prior to a response that the consumer viewed the email, again if it was viewed at all. A “marketing-range stimulus” may be created as described herein based upon a marketing-range response rate.

Collectively, the statistically-inferred threshold response rate and the marketing-range response rate may be utilized, as described herein, to enhance response rate attributions related to other actual marketing channels or related to marketing-interval channels (e.g., mass media, etc.), respectively. As such, the statistically-inferred threshold response rate and the marketing-range response rate may collectively be referred to as a “statistically-inferred time interval-based response rate” herein. Further, a threshold stimulus and a marketing-range stimulus may each be collectively referred to as a “time interval-based stimulus” herein.

The statistically-inferred threshold response rate described herein solves this informational gap and is utilized to adjust and/or offset marketing attributions credited to particular marketing channels. The present technology creates a threshold stimulus (e.g., a base or background stimulus) based upon the statistically-inferred threshold response rate. The threshold stimulus then “competes” for marketing attribution with actual marketing channels, meaning that the threshold stimulus operates as another stimulus that is assigned credit/attribution in contributing to sales alongside stimuli from actual/real marketing channels/contacts. The calculated contribution to sales that is represented by the threshold stimulus by comparison/competition with actual marketing channels more accurately characterizes the actual contributions of the real marketing channels and contacts. As such, more accurate marketing attribution to the actual marketing channels may be calculated by use of the time interval-based statistically-inferred response attributions described herein.

Unlike the other marketing channels and other marketing contacts that have a particular time period associated with them, the threshold stimulus may be considered omnipresent, meaning that the threshold stimulus may be considered to be continually active in the market, and consumers may make purchasing decisions based upon this threshold stimulus even in the absence of a formal marketing campaign. Because the threshold stimulus is active over an extended period of time, the threshold stimulus may be scaled proportionally to the size of a training window for inference of the threshold response rate.

Crediting attribution to the threshold stimulus involves maintaining a count of a number of customers that did not receive any marketing contacts during the training period. By maintaining the count of the number of customers that did not receive any marketing contacts during the training period, the threshold stimulus may be used to more accurately assign credit to the other (actual) marketing actions/channels that occurred during the training period. With more accurate attributed credit assignment to past marketing actions, future marketing decisions may be improved.

It should be noted that conception of the present subject matter resulted from recognition of certain limitations associated with marketing channel attributions for crediting marketing channels for respective contributions to sales. For example, it was observed that prior technologies for sales attribution to marketing channels is limited to information related to formal marketing contacts and marketing campaigns (e.g., emails, coupons, and other forms of advertisements). However, it was determined that there is another influence in the market that is not directly related to formal marketing channels. It was determined that a certain portion of consumers may buy products and/or services for a variety of reasons that are not related to formal marketing channels. For example, it was determined that a certain portion of consumers may buy products and/or services, such as tires or automobile repair, because of need or proximity to a particular service station without any influence of any particular formal marketing channel. Based upon these observations and determinations, it was further determined that there is no prior technology that adequately quantified a proportion of sales volume that would occur in a marketplace outside of or absent formal marketing channels based upon time interval-based stimuli. It was further observed that mass media types of advertisements, such as broadcast audio and/or video advertisements, may be observed by consumers during a certain time period, and yet have influence on sales that occur at very different times. It was additionally observed that there is no way by which to actually know if a particular consumer has heard and/or has viewed a particular mass media advertisement. It was further determined, based upon these observations, that prior computing technologies were unable to properly calculate and account for these mass media marketing attributions. The present subject matter, as described above and in more detail below, improves marketing channel attributions by providing time interval-based statistically-inferred response attributions that account for the background/threshold sales that may occur without formal marketing contacts and that may occur as a result of mass media advertising events. As such, improved marketing channel attributions may be obtained through use of the present computing technology.

The time interval-based statistically-inferred response attributions described herein may be performed in real time to allow prompt adjustment of formal marketing channel attributions. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

FIG. 1 is a block diagram of an example of an implementation of a system 100 for time interval-based statistically-inferred response attributions. A computing device_1 102 through a computing device_N 104 communicate via a network 106 with several other devices. The other devices include a server_1 108 through a server_M 110. The server_1 108 through the server_M 110 may generate marketing contacts/promotions, such as promotional emails, promotional advertisements, coupons, and other marketing stimulus as part of one or more marketing campaigns. The server_1 108 through the server_M 110 may also provide content for mass media types of marketing contacts, such as audio and/or video advertisements. A database 112 may store marketing campaign information, such as offers, coupons, promotional information related to consumers to which marketing contacts have been made, and other marketing information.

The computing device_1 102 through the computing device_N 104 may be used by consumers/users to respond to marketing contacts generated by the server_1 108 through the server_M 110. The computing device_1 102 through the computing device_N 104 may also be utilized by consumers, point of sale (POS) attendants, or others to purchase products and/or services outside of (e.g., without) any direct marketing contact from an advertiser.

As will be described in more detail below in association with FIG. 2 through FIG. 5, any of the computing device_1 102 through the computing device_N 104 and the the server_1 108 through the server_M 110 may provide automated time interval-based statistically-inferred response attributions. The automated time interval-based statistically-inferred response attributions are based upon inference of marketing attributions for sales that may occur without any advertising influence by an advertiser or that may occur from mass media advertising that takes place over time. As such, the present technology may be implemented at a user computing device or server device level. A variety of possibilities exist for implementation of the present subject matter, and all such possibilities are considered within the scope of the present subject matter.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_1 108 through the server_M 110 may include any device capable of providing data for consumption by a device, such as the computing device_1 102 through the computing device_N 104, via a network, such as the network 106. As such, the server_1 108 through the server_M 110 may each include a web server, application server, or other data server device.

The database 112 may include a relational database, an object database, or any other storage type of device. As such, the database 112 may be implemented as appropriate for a given implementation.

FIG. 2 is a block diagram of an example of an implementation of a core processing module 200 capable of performing time interval-based statistically-inferred response attributions. The core processing module 200 may be associated with either the computing device_1 102 through the computing device_N 104 and/or with the server_1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of time interval-based statistically-inferred response attributions in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 (“processor”) provides hardware that performs computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, voice command processing unit, or any other type of input device by which the user may interact with and respond to information on the display 204.

It should be noted that the display 204 and the input device 206 may be optional components for the core processing module 200 for certain implementations/devices, or may be located remotely from the respective devices and hosted by another computing device that is in communication with the respective devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides hardware, protocol stack processing, and interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a statistical threshold response attribution storage area 212 that stores information and results related to time interval-based statistically-inferred response attributions within the core processing module 200. The memory 210 also includes a promotional management area 214 that provides storage and execution space for one or more promotionally-related applications that may be used to distribute or respond to marketing contacts depending upon whether the particular implementation of the core processing module is at a server device or client device, respectively.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A statistical time interval-based response attribution module 216 is also illustrated. The statistical time interval-based response attribution module 216 provides analytical processing capabilities related to statistical threshold response attribution calculations for the core processing module 200, as described above and in more detail below. The statistical time interval-based response attribution module 216 implements the automated time interval-based statistically-inferred response attributions of the core processing module 200.

It should also be noted that the statistical time interval-based response attribution module 216 may form a portion of other circuitry described without departure from the scope of the present subject matter. Further, the statistical time interval-based response attribution module 216 may alternatively be implemented as an application stored within the memory 210. In such an implementation, the statistical time interval-based response attribution module 216 may include instructions executed by the CPU 202 for performing the functionality described herein. The CPU 202 may execute these instructions to provide the processing capabilities described above and in more detail below for the core processing module 200. The statistical time interval-based response attribution module 216 may form a portion of an interrupt service routine (ISR), a portion of an operating system, a portion of a browser application, or a portion of a separate application without departure from the scope of the present subject matter.

A timer/clock module 218 is illustrated and may be used to determine timing and date information, such as timing relative to mass media or other marketing channels relative to sales, as described above and in more detail below. As such, the statistical time interval-based response attribution module 216 may utilize information derived from the timer/clock module 218 for information processing activities, such as the time interval-based statistically-inferred response attributions.

The database 112 is again shown within FIG. 2 associated with the core processing module 200. As such, the database 112 may be operatively coupled to the core processing module 200 without use of network connectivity, as appropriate for a given implementation.

The CPU 202, the display 204, the input device 206, the communication module 208, the memory 210, the statistical time interval-based response attribution module 216, the timer/clock module 218, and the database 112 are interconnected via an interconnection 220. The interconnection 220 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. It should also be understood that, though the database 112 is illustrated as a separate component for purposes of example, the information stored within the database 112 may also/alternatively be stored within the memory 210 without departure from the scope of the present subject matter. Accordingly, the core processing module 200 may take many forms and may be associated with many platforms.

FIG. 3 is a diagram of an example of an implementation of a customer database record 300 stored within the database 112 that may be used to perform the time interval-based statistically-inferred response attributions according to an embodiment of the present subject matter. As described above, information from the database 112 may additionally and/or alternatively be stored within the memory 210.

The customer database record 300 includes a customer ID information field 302, a date information field 304, time/interval information field 306, a stimulus and response information field 308, an offer information field 310, and a channel information field 312. It should be noted that other fields, as described with respect to certain other information below, may be included within the customer database record 300, as appropriate for a given implementation. It is understood that these additional fields may form a portion of the customer database record 300. For example, the stimulus and response information field 308 may store any information regarding coupons, discounts used by the consumer, demographics information, and information regarding stimuli to be credited for a response. Similarly, the offer information field 310 may include item information, such as stock keeping unit (“SKU”) number information, and other information. Many other possibilities exist for information storage within the customer database record 300, and all such possibilities are considered within the scope of the present description.

It should be noted that the date information field 304 and the time/interval information field 306 may specify ranges of dates and/or times, as appropriate for the given stimulus. For example, where a broadcast advertisement runs over several days, the date information field 304 may include the respective range of dates. Additionally, where a broadcast advertisement runs at several different times, the time/interval information field 306 may include the respective times or ranges of times.

As also described above, the core processing module 200 may be implemented at any of the computing device_1 102 through the computing device_N 104 and/or with the server_1 108 through the server_M 110, as appropriate for a given implementation. As such, the core processing module 200 and the statistical time interval-based response attribution module 216 are referred to generally below for ease of description herein, with the understanding that the described functionality may be implemented at any one or more of the respective devices, or distributed across devices, as appropriate for the given implementation.

Within this context, the core processing module 200 as implemented may query the database 112 for one or more customer database records 300, and may obtain a list of responses (e.g., R₁ . . . R₁) and stimuli (e.g., S₁ . . . Sᵢ) associated with a particular consumer. A promotion, such as an offer, or more generally any communication and/or events (e.g., birthdays and anniversaries, elections, snowstorms, etc.), that may lead to a response is referred to herein as a “stimulus.” Information about a given stimulus (e.g., Sᵢ) may include customer identification (“ID”) information, contact date information, channel information, product and offer information, and any potential discount information, each as represented within the respective customer database record 300. Stimuli may occur at a point in time or may occur over an interval of time and/or days.

It should additionally be noted that events, such as snowstorms, may prevent people from getting to a shopping mall, or may also cause a surge in snow shovel sales or bread/milk sales. As such, inclusion of these and similar types of events within the models described herein may increase the accuracy of the respective models over time. As such, a “stimulus,” as described herein may include anything that may affect a likelihood of a response.

As described above, a unique threshold stimulus (e.g., a “background” or “baseline”) stimulus (e.g., S_{B}) may also be presumed to exist for each customer, and a representation of the threshold stimulus may be programmatically created for use and processing as described herein. The purpose of the unique threshold stimulus is to accumulate credit for responses that may be reasonably expected to occur even in the absence of any marketing contacts or other stimuli. The threshold stimulus may be considered to be omnipresent, in that the threshold stimulus may be considered to be continually active in the market, and consumers may make purchasing decisions based upon this threshold stimulus even in the absence of a formal marketing campaign.

It should be noted that the same principle may be used to process responses from new customers not previously stored in the database. A separate non-customer background response rate (r′) may be learned by the processing described herein. The non-customer background response rate only competes for credit for responses from those customers not previously stored in the customer database. A numerator of the non-customer background response rate is the number of those non-customer responses, and a denominator of the non-customer background response rate is the number of potential customers outside of the database.

Information about a given response (e.g., R₁) may include customer ID information, response date information, stock keeping unit (“SKU”) number information, any relevant information regarding coupons and/or discounts used by the consumer, demographics information, and information regarding stimuli to be credited for a response, again each as represented within the respective customer database record 300.

The core processing module 200 may receive an unassociated list of stimuli and responses for a particular customer (e.g., S₁ S₂ S₃ R₁ R₂ S₄ S₅ R₃ S₆). To determine an amount that each stimulus (e.g., S₁-S₆) has contributed (if at all) to any of the responses (e.g., R₁-R₃), the statistical time interval-based response attribution module 216 may calculate a response attribution value (e.g., a value indicative of the likelihood that a given stimulus “S” caused a given response “R”). The response attribution values represent a credit assignment to a particular stimulus, for an associated response from a recipient (e.g., during a marketing campaign). A stimulus, with an associated response from a recipient for that stimulus, is represented as a stimulus-response (e.g., “S-R”) pair. An example of the S-R pairs for the stimuli and responses in the unassociated/unordered list of stimuli and responses described above, (e.g., stimuli S₁-S₆ and responses R₁-R₃, respectively) is provided in the following Table 1. Table 1 additionally adds a row at the bottom that includes the unique threshold stimulus (S_{B}) within respective stimulus-response pairs for each response.

TABLE 1
Stimulus/Response Pairs, including
Threshold Stimulus/Response Pairs

{S1, R1}, {S1, R2}, {S1, R3}
{S2, R1}, {S2, R2}, {S2, R3}
{S3, R1}, {S3, R2}, {S3, R3}
{S4, R1}, {S4, R2}, {S4, R3}
{S5, R1}, {S5, R2}, {S5, R3}
{S6, R1}, {S6, R2}, {S6, R3}
{SB, R1}, {SB, R2}, {SB, R3}

It should be noted that the example above in Table 1 utilizes an unassociated list of stimuli and responses. However, if a particular list of stimuli and responses are chronological, then a smaller number of S-R pairs may result because stimuli that occur after responses would not be appropriate to consider within S-R pairings. This may be recognized by the fact that subsequent stimuli could not have contributed to the particular prior response. As such, S-R pairings of non-contributing stimuli with prior responses may be omitted.

The statistical time interval-based response attribution module 216 “scores” the respective S-R pairs to generate response attribution values for each S-R pair. For a direct response (e.g., R₁), the response includes information as to which stimuli to credit. For example, the specific information associated with the response may include information that the customer filled out a card specifying which communication(s) caused the consumer to respond to the communication, that the customer used a coupon associated with a particular stimulus (e.g., any of the set of actual stimuli), that a response is electronically captured through an email “click-through” link, or other information that allows direct attribution to a particular marketing channel. The statistical time interval-based response attribution module 216 generates a response attribution value indicative of the amount of credit attributed to stimulus S₂ for response R₁. The generated response attribution values for each S-R pair may be calculated accordingly for direct responses. It should be noted that with direct responses, such as where a consumer checked a box on a card indicating where they learned of a particular product and/or service, one hundred percent (100%) credit may be applied to the respective selected stimulus, and zero percent (0%) may be applied to the other stimuli. Alternatively, where a series of advertisements (e.g., emails) have been distributed and uncertainty exists with respect to how many of the advertisements influenced the purchase, the respective direct response may be treated as an inferred response, as described in detail below.

However, where a given response represents an inferred response (e.g., a response where the correct attribution is not known a priori, but may be statistically inferred), the statistical time interval-based response attribution module 216 performs additional processing and executes three models to derive probabilistic attributions for the respective marketing channels.

A first model is a “response-rate model,” a second model is a “time model,” (also referred to herein as a second “time delay model”), and a third model is a “reach probability model” (estimating the likelihood the stimulus S actually reached the customer). The statistical time interval-based response attribution module 216 may utilize the respective models to generate a response attribution value for a particular stimulus that is associated with a particular response. The resulting response attribution value for a particular marketing channel is calculated based on an output of the first model, an output of the second model, an output of the third model, or any combination thereof, as appropriate for a given implementation.

The first response-rate model rates the association between a particular stimulus (e.g., stimulus Sᵢ) and a given response (e.g., response R) to attribute a “response rate” to each S-R pair. For the first response-rate model, inputs include customer attributes (e.g., gender, age, income, etc.), channel information, stimulus information (e.g., discount, product, etc.), and the related response information.

Regarding the association between a particular stimulus and response, where a particular stimulus is, for example, a twenty percent discount on an electronics purchase (e.g., 20% off on electronics coupon), the stimulus is likely to be more closely related to an electronics purchase than to a purchase of a pair of shoes. As such, there may be a stronger association between an electronics discount coupon stimulus and an electronics purchase, than between the same electronics discount coupon stimulus and a shoe purchase.

To execute the first response-rate model and assign a response attribution value to the S-R pairs, the statistical time interval-based response attribution module 216 determines the stimuli that may have contributed to a particular response. The statistical time interval-based response attribution module 216 accesses from the database 112 one or more customer database records 300, as described above in association with FIG. 3, that include customer information associated with stimuli that were sent to customers at a time prior to a particular response.

If the stimuli are over an interval of time, they may be considered as prior to the respective response if their beginning time was prior to the respective response, even where the stimuli persisted/endured beyond the respective response. The statistical time interval-based response attribution module 216 queries the database 112 for customer database records 300 that include stimuli regarding timing information (e.g., the date and time a promotion was sent to a consumer) that indicates that the respective stimuli occurred before the time a particular response was received by the statistical time interval-based response attribution module 216.

The length of the time window may be configurable (e.g., by users of the statistical time interval-based response attribution module 216). It may be typically assumed that the further back in time a particular stimulus may have appeared before a particular response was received, the less likely it may be that the particular stimulus may have contributed to the particular response.

In some implementations, the first response-rate model may be formed as a composite of multiple models. For example, if there are a number of different types of responses, the statistical time interval-based response attribution module 216 may generate a sub-model for each different type of response. Different types of responses may include clicks, downloads, and other types of responses, and a sub-model may be created for each different type of response. The first response-rate model may select one of the sub-models based on the unique type of a given response within the available types of responses. Additionally, multiple models may be generated based on the inputs (e.g., customer segments, channels, etc.) to the first response-rate model.

In addition to calculating a probability of a response, the first response-rate model may also be based on various techniques for modeling responses for a marketing campaign. For example, the first response-rate model may be based upon a ratio of a sum of the credit received by a given stimulus divided by the total reach of the stimulus (e.g., Σ Creditₛ/Σ Reachₛ). The statistical time interval-based response attribution module 216 may compute this ratio for each type of stimulus. For purposes of this example, the “reach” of a given stimulus with regard to a particular customer represents a probability that the stimulus was actually seen by that customer. The total reach is the sum of these probabilities across all of the customers.

It should be noted that this ratio accounts for a scenario where a particular stimulus causes multiple responses. For example, if a customer receives one (1) stimulus and the statistical time interval-based response attribution module 216 receives two responses (e.g., R₁ and R₂), a credit of one (1) may be assigned to the first response (R₁) and a credit of one (1) may also be assigned to the second response (R₂). The value of the ratio (Σ Credit/Σ S) equals two (e.g., or 2/1), representative of an expected number of responses.

The first response-rate model may also be based upon a user definition of a response for a particular stimulus. For example, based on a coupon that provides a twenty percent (e.g., 20%) discount on electronics purchases, a user may define a response as being an electronics purchase. In this example, the statistical time interval-based response attribution module 216 may use the user's definition to rate the association between the stimulus and a given response. For example, if the response is an electronics purchase, the response may be attributed to the appropriate stimulus (i.e., the coupon that provides the twenty percent (e.g., 20%) discount on electronics purchases).

The second time model weights the output of the first response-rate model based upon an amount of time (e.g., time delay) between a given stimulus and a particular response. By weighting the output of the first response-rate model based upon the amount of time delay between the stimulus and the response, the second time model scales the response rate based upon a time-delay probability density function (pdf). The inputs used to train the second time model may include the generated response attribution values and sample time delays. The result of training the second time model may include one or more time delay parameters associated with a time delay distribution (e.g., power law parameters for a power law distribution, or other parameters as appropriate for a different form of distribution).

It is understood that many different types of distributions may be implemented. For example, in addition to the power law distribution that is utilized primarily within the examples herein, a polynomial distribution, a log-normal distribution, or other distribution may be utilized, as appropriate for a given implementation. As such, use of any type of distribution to implement the technology described herein is considered within the scope of the present subject matter.

Once the second time model is trained, the second time model takes a delay as input, and produces as output a relative likelihood that such a delay may be observed. For the threshold (e.g., background) stimulus, the second time model operates as a scaling value equal to one (1) divided by the size of the training window. For purposes of the present example, the training window may be considered a range or amount of time encompassing the training data of stimuli and responses being processed from the database.

It should be noted that in some cases, the exact timing of stimuli may not be known. Instead, only a range of possible times of stimuli may be known. In such a case, the second time delay model may compute a weighting that is an average across the respective time interval. This average may be computed by integrating the probability density function (pdf) of the time delay distribution, which is the cumulative distribution function (CDF), and evaluating the CDF over the range of possible delays.

If the exact timing of a stimulus is known, such a stimulus is referred to herein as a “point” stimulus, with “point” stimuli referring to the category or plural. If the timing of the stimulus is only known to occur within an interval of time, such a stimulus is referred to herein as an “interval” stimulus, with “interval” stimuli referring to the category or plural.

Regarding the interval stimuli, and for purposes of example, it is assumed that a given interval stimulus lasts from a stimulus start time to a stimulus stop time (e.g., from tₛ₁ to tₛ₂). If a response occurs at a given response time (e.g., t_{R}), then there are two cases where the interval stimulus may share credit for the response.

The first case where the interval stimulus may share credit for the response is where the response time occurs after the stimulus stop time (e.g., t_{R} occurs after tₛ₂). In such a situation, the possible delay ranges from the response time minus the stimulus stop time and extends back in time to the response time minus the stimulus start time (e.g., possible delay=(t_{R}−tₛ₂) to (t_{R}−tₛ₁)).

The second case where the interval stimulus may share credit for the response is where the response time occurs between the stimulus start time and the stimulus stop time (e.g., t_{R} occurs between tₛ₁ and tₛ₂). In such a situation, the possible delay ranges from time zero (0) to the response time minus the stimulus start time (e.g., possible delay=0 to (t_{R}−tₛ₁))

To calculate the exact delay factor, the CDF may be evaluated for the assumed response delay distribution at the range limits specified above. Example time delay distributions that may be used include log-normal, power law, and polynomial distributions, but others may be utilized in a similar manner. Additionally, if appropriate for a given implementation, a numerical approximation may be used to evaluate the CDF. Such a technique may be useful, for example, with the log-normal distribution.

The following are some example CDF calculations and probability density function calculations that may be utilized within certain of the respective time delay distributions described above.

For the power law time delay distribution, the pdf and CDF may be calculated as shown within the following Equation (2) and Equation (3), respectively.

pdf: f(x; α, k)=(α−1)/k*(x/k)^{(-α)}, x>k Equation (2)

CDF: F(x; α, k)=1−(x/k)^{(-α)} Equation (3)

Within Equation (2) and Equation (3), the parameter alpha (e.g., a) controls the shape of the distribution, and the parameter “k” is the minimum value of the distribution. The domain of Equation (2) is represented as “x>k.”

For the polynomial time delay distribution, the pdf and CDF may be calculated as shown within the following Equation (4) and Equation (5), respectively.

pdf: f(x; p, L)=(p+1) (L−x)^{p}/L^{(p+1)}, x>0, x<L Equation (4)

CDF: F(x; p, L)=1−(1−x/L) ^{(p+1)} Equation (5)

Within Equation (4) and Equation (5), the parameter “p” is the degree and the parameter “L” is the limit. The domain of Equation (4) is represented as “x>0, x<L.”

For the log-normal time delay distribution, the pdf and CDF may be calculated as shown within the following Equation (6) and Equation (7), respectively.

pdf: f(x; μ, σ)=e^{(-(ln x-μ)̂2/2σ̂2)}/(x σ sqrt(2π)), x >0 Equation (6)

CDF: F(x; μ, σ)=½+½*erf [(ln x−μ)/sqrt(2)/σ] Equation (7)

Within Equation (6) and Equation (7), the parameter mu (e.g., μ) is the location, the parameter sigma (e.g., a) is the scale, and the symbol “it” represents that mathematical constant value pi. The function “erf” represents an error function, and the function “sqrt” represents the square root function. Within Equation (6), the independent variable “x” is multiplied by the variable sigma (e.g., a) and the square root of the value two pi (e.g., 2π). The domain of Equation (6) is represented as “x>0.”

In all of these cases described above, for interval stimuli, the delay factor may be calculated as shown below within Equation (8).

delay_factor=[CDF(R_Max)−CDF(R_Min)]/[R_Max−R_Min] Equation (8)

Within Equation (8), the value “R_Max” is the maximum of the range (e.g., max_of_range), and the value of “R_Min” is the minimum of the range (e.g., min_of range).

The calculated delay factor represents the average over the interval of the values used for point-type stimuli, which are based on evaluating the probability density function (pdf) at the delay. It should be noted that the CDF is the integral of the pdf, and as such, the CDF may be used to compute the average pdf value over a range. An example implementation of a use of the delay factor calculation shown above within Equation (8) is shown within example pseudo syntax further below.

The third reach probability model modulates the amount of credit given to a stimulus based upon the likelihood that the particular stimulus was actually seen by the respective customer. The third reach probability model may be implemented by an outside agency, based on ratings information acquired by questionnaires, set-top boxes (STBs), demographics, and other types of information about the customers and media channels.

As such, the output of the third reach probability model may include the likelihood that the stimulus actually reached a particular customer. For the threshold (e.g., background) stimulus, the reach may always be considered to be one hundred percent (100%) because, as described above, the threshold stimulus may be considered to always be active (e.g., omnipresent). The third reach probability model may be considered optional. As such, if the third reach probability model is not available, then the reach probabilities may all be assumed to be one hundred percent (100%).

The processing of the three-model approach described herein may operate to programmatically learn the impact of each channel in terms of aggregate credit of the respective channels or number of responses, as well as the apportionment between response rate and total reach as shown in Equation (9) (below). If the third reach probability model is not used and all the reach probabilities are assumed to be one hundred percent (100%), then the programmatic processing of the three-model approach learns the left side of the Equation (9), without learning the apportionment between response rate and total reach on the right side of the Equation (9).

Total_Responses=Response_Rate*Total_Reach Equation (9)

In this case, the system still learns how many responses result from various channels, but does not specify which part is due to the response rate versus which part is due to the total reach. However, this total response information is useful, for example, in determining how much revenue is from television advertising versus newspaper ads, internet ads, emails, search engines (e.g., paid searches such as pay-per-click style ads), and other forms of advertisements. The “Total_Responses” attributed to a particular offer or channel is the sum of all their credits.

The outputs from the three models may be multiplied together to compute a score indicative of a likelihood that a particular stimulus caused a particular response. The scores may be further normalized across the respective S-R pairs, and a credit (e.g., a normalized response attribution value) may be computed for (assigned to) each stimulus.

Prior to the statistical time interval-based response attribution module 216 executing the first response-rate model and the second time delay model, the statistical time interval-based response attribution module 216 trains (e.g., iteratively) the respective models to determine values for response rate parameters to be associated with the first response-rate model and time delay parameters associated with the second time delay model. It should be noted that training or development of the third reach probability model may be performed ahead of time, while training of the first response-rate model and the second time delay model is iterative and is integrated more closely into the entire learned response-rate attribution process.

FIG. 4 through FIG. 5 described below represent example processes that may be executed by devices, such as the core processing module 200, to perform the automated time interval-based statistically-inferred response attributions associated with the present subject matter. Many other variations on the example processes are possible and all are considered within the scope of the present subject matter. The example processes may be performed by modules, such as the statistical time interval-based response attribution module 216 and/or executed by the CPU 202, associated with such devices. As such, the statistical time interval-based response attribution module 216 and/or the CPU 202 may be considered a “response attribution engine” for purposes of the present description when executing the processes described below. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 4 is a flow chart of an example of an implementation of a process 400 for time interval-based statistically-inferred response attributions. At block 402, the process 400 creates, by a processor, a time interval-based stimulus based upon a statistically-inferred time interval-based response rate, where the time interval-based stimulus accounts over time for a proportion of responses that occur without being attributable to other stimuli. At block 404, the process 400 retrieves a response. At block 406, the process 400 calculates, using the time interval-based stimulus and the response, a time-interval response attribution value, where the time-interval response attribution value is calculated by applying a combination of a first response rate model and a second time delay model that weights output of the first response rate model based upon a continuous range of time delays between a minimum and maximum difference in time that separate the time interval-based stimulus and the response.

FIG. 5 is a flow chart of an example of an implementation of a process 500 for time interval-based statistically-inferred response attributions that implements an expectation maximization (E-M) process. At decision point 502, the process 500 makes a determination as to whether an indication to train and process the first response-rate model and the second time delay model has been detected. The indication to train and process the respective models may be detected in response to a user indication to train the respective models, may be detected in response to a configuration event, may be detected in response to ongoing processing for determining probabilistic response attribution values for particular stimuli and associated responses (e.g., sets of S-R pairs), or otherwise as appropriate for a given implementation. Training the system may be performed by processing multiple customer data records. Once the parameters are learned, any number of customers may be scored (e.g., one customer to all customers). As described above, a “score” is the amount of credit to be applied to each stimulus. A score may be determined for each S-R pair.

It should be noted that the process 500 is depicted and described to include both initial training of the respective models, and further includes iterative ongoing processing to derive probabilistic response attribution values and to derive credit scores for the respective S-R pairs. It should further be noted that the two distinct phases of initial training and ongoing processing to derive probabilistic response attribution values may be partitioned into two different processes, as appropriate for a given implementation.

In response to determining at decision point 502 that an indication to train and process the first response-rate model and the second time delay model has been detected, the process 500 obtains (receives, retrieves, etc.) values for response rate parameters, time delay parameters, reach probabilities, stimuli information, and response information at block 504. As described above, the process 500 may obtain/receive one or more customer database records, such as the customer database record 300 described above in association with FIG. 3 that may be obtained from the database 112 or from other sources/repositories (not shown). As also described above, the customer database records 300 may include other information, as appropriate for a given implementation.

The initial values of the response rate parameters and time delay parameters may be randomly assigned for the initial pass through the training phase of the process 500. Initial estimates for the response rate parameters may be based upon the overall number of responses divided by the overall number of stimuli. Alternatively, the initial values of the response rate parameters and time delay parameters may be based upon values derived from direct response attribution values or from previous training runs on similar data.

Based upon the received and obtained values and information, the process 500 begins execution for response attribution value processing and generates response attribution values at block 506. At block 508, the process 500 generates response rate parameter values. At block 510, the process 500 generates time delay parameter values.

It should be noted that the process 500 iteratively generates improved values for response rate parameters and time delay parameters through the application of an expectation maximization (“E-M”) process, as described in more detail below. The process 500 makes a determination at decision point 512 as to whether to generate a report. In response to determining at decision point 512 to generate a report, the process 500 generates a report including information indicative of the initially derived probabilistic response attribution value associated with the stimulus (Sᵢ) for the respective associated response (R) at block 514.

In response to generating the report at block 514, or in response to determining at decision point 512 not to generate a report, the process 500 makes a determination at decision point 516 as to whether processing of stimulus and response pairs is completed. In response to determining that processing of stimulus and response pairs is not completed, the process 500 applies the expectation maximization (E-M) processing at block 518. The E-M processing will be described in more detail below.

The process 500 returns to block 504 to receive/obtain current parameter values (e.g., values for response rate parameters and time delay parameters), stimuli information, response information, and other information included in the respective customer database record 300. The process 500 iterates as described above to both improve the training of the respective models and to derive improved probabilistic response attribution values associated with stimuli for the respective associated responses. As described above, as the respective models improve over time through additional cycles of the process 500 and the E-M process, improved probabilistic response attribution values may be obtained.

As noted above and as described in more detail below, the process 500 is depicted to include both the initial training cycle of the respective models, and ongoing processing to derive probabilistic response attribution values with further training to improve the training of the respective models. For purposes of the present description, the two distinct phases of initial training and ongoing processing to derive probabilistic response attribution values and further train the models are depicted within in a single process. However, it is understood that the two distinct phases of the process 500 may be partitioned into two different processes, as appropriate for a given implementation. As such, during ongoing processing after the initial training cycle, the process 500 iterates based on the received/obtained values and information and generates response attribution values and assigns the response attribution values (i.e., credit) to the stimuli at block 506. Using the credit assigned to each stimulus, the process 500 calculates a subsequent value for the response rate parameter of the response-rate model at block 508, which will be described in more detail further below. Using the credit as a weight for each stimulus in a regression, the process 500 calculates a subsequent value for the respective time delay parameters of the time delay model at block 510, which will also be described in more detail further below. The process 500 continues to iterate to decision point 516, and then to block 518 to further improve training of the respective models based upon the calculated values.

It should be noted that certain models, such as the power law model, may provide for use of regression. A regression includes a relationship between two variables using data points. For example, a regression may include fitting a curve to data points. Types of regressions may include weighted regressions, linear regressions, quadratic regressions, polynomial regressions, spline function models, sinusoid models, and so forth. Any of such regression models may be used as appropriate for the given implementation.

Returning to the description of decision point 516, in response to determining that processing of stimulus and response pairs is completed, the process 500 returns to decision point 502 and iterates as described above. The stop condition may be any of several criteria such as a determination of convergence of the calculated values of the response rate and time delay parameters, a determination that a threshold number of iterations of calculating values for the response rate and time delay parameters has occurred, and a determination that a threshold amount of computing resources have been expended by the process 500. It should further be noted that the respective parameters may be considered to asymptotically approach improved values over time. As such, the stop condition may be based upon a determination of how close the resulting values of the current iterations are to an asymptotical long-term stability. In response to determining at decision point 516 that processing of stimulus and response pairs is completed, the process 500 generates a report including information indicative of the response attribution value for a stimulus and an associated response at block 520.

As such, the process 500 calculates the response attribution value for each stimulus (Sᵢ) associated with a given response (R) for a particular customer (e.g., as indicated by an S-R pair). For each stimulus (Sᵢ) with onset occurring at a time prior to a response (R), the process 500 calculates an S-R pair raw score (raw_{SR}) as a function of the response-rate model (e.g., the response rate parameter (rₒ), where “o” represents an offer) and the time delay model (e.g., the time delay parameters, where, for the example of the power law distribution, the parameters are α_{c} and k_{c}, where “c” represents a channel, and where delay_{SR} represents a time delay between stimulus Sᵢ and response R) The raw score may be associated with an S-R pair and may be normalized across the stimuli to generate the respective response attribution value for the S-R pair.

The description below provides additional detail related to the processing described above in association with the process 500. The following example pseudo-code corresponds to the foregoing processes of calculating the response attribution value. The following example pseudo code provides two primary aspects of processing: it calculates a delay factor, and performs normalization of the credits assigned to the respective stimuli. As described above, the processing to calculate the delay factor for interval stimuli may be partitioned into a function/routine that may be called. The example pseudo code below shows the functionality as in-line pseudo code to avoid partitioning within the present description.

For each customer {

For each R {

For each S that began prior in time to R {

Let o = offer (s)
Let c = channel (s)
If(s is point stimulus) {

Let delay_{SR} = time (r) − time (s)
delay_factor_{SR} = pdf(delay_{SR})

}
Else If(s is interval stimulus) {

If(time(r) > time(s_{end}) {

min = time(r) − time(s_{end})
max = time(r) − time(S_{begin})

}
Else if(time(r) > time(S_{begin}) AND time(r) <
time(s_{end})) {

min = 0
max = time(r) − time(S_{begin})

}
delay_factor_{SR} = (CDF(max) − CDF(min)) /
(max − min)

}

raw_{SR} = rₒ * delay_factor_{SR} * reachₛ
}
For each S that began prior in time to R {

credit_{SR} = raw_{SR} / Σₛ raw_{SR}

}

}

}

As can be seen from the above example pseudo code, for point stimuli, the time delay factor may be calculated by invoking the respective probability density function for the respective distribution (e.g., power law time delay distribution, polynomial time delay distribution, log-normal time delay distribution, etc.), as described above.

For interval stimuli, the example pseudo code first determines whether the time of the response is after the end of the interval (e.g., “If(time(r)>time(s_{end})”) or whether the response is between the start and end times of the interval (e.g., “Else if(time(r)>time(s_{begin}) AND time(r)<time(s_{end})”). The example pseudo code assigns minimum and maximum times based upon the respective conditions, and calculates the delay factor as described above for interval stimuli. It is this sequence of conditionals and processing to calculate the time delay factor that may be partitioned into a function call or routine, as appropriate for a given implementation.

The example pseudo code then assigns the S-R pair raw score from the calculated delay factor for the respective type of stimulus (e.g., point versus interval), the response rate, and the reach probability. The process then assigns credit (i.e., the response attribution value) to each respective stimulus. The response attribution value is based on a ratio that accounts for the scenario of multiple stimuli and the scenario where a single stimulus causes multiple responses. For example, two stimuli (e.g., S₁ and S₂) may be associated with a given response (R). The example pseudo code executes the response-rate model to calculate a first raw score (e.g., for S₁, rawₛᵢᵣ=1.0). The processing executes the response-rate model to calculate a second raw credit score (e.g., for, S₂, rawₛ₂ᵣ=0.5). The response-rate model normalizes the respective raw credit scores (e.g., rawₛ₁ᵣ and rawₛ₂ᵣ) to calculate the response attribution values (e.g., creditₛ₁ᵣ and creditsₛ₂ᵣ, for S₁ S and S₂). The resulting credits are derived as shown in the example pseudo code (e.g., creditₛ₁ᵣ equals 1.0/1.5, or 2/3, and creditₛ₂ᵣ equals 0.5/1.5, or ⅓). By normalizing the respective raw scores (e.g., rawₛ₁ᵣ and rawₛ₂ᵣ), the summation of the values for the respective assigned credits (e.g., creditₛ₁ᵣ and creditₛ₂ᵣ) equals one (1), representing that the total credit across all stimuli associated with response (R) has a value of one (1), which is consistent with the objective of a complete assignment of attributions.

Weight values may also be associated with the response-rate model and the time delay model. The weight values may be determined based upon predicted reliability of the response-rate model and the time delay model. For example, if a determination is made that the time delay model is twice as accurate at predicting the response attribution value as the response-rate model is at predicting the response attribution value, processing may be performed to associate the response-rate model with a weight value of one half (0.5), indicating that the response weight value receives half as much weight in calculating the response attribution value as the time delay model.

As described above, the processing calculates a subsequent value for the response rate parameter based on the response attribution value calculated in the previous iteration (see the process 500 described above). For each offer or category of stimuli, the processing may initialize two values (e.g., value1 and value2) to zero. The first value (e.g., value1) is indicative of an amount of credit assigned to all stimuli from the offer or category “o” across all responses for all customers. The second value (e.g., value2) is indicative of the sum of the reach of stimuli from the offer or category “o” to all customers. For each stimulus with the offer or category “o,” the processing increments the second value (value2) by the reach probability from the third reach probability model. Additionally, for each response (R) associated with a stimulus from the offer or category “o,” the first value (value1) is incremented by the response attribution value associated with the stimulus-response pair. The processing calculates a subsequent value for the response rate parameter by dividing the first value (value1) by the second value (value2). For the threshold (background) stimulus, the second value (value2) is a count of all customers in the database, regardless of whether they received any other stimuli during the training period.

The following additional example pseudo code corresponds to the foregoing processing of calculating a subsequent value for the response rate parameter.

For each offer o {

Value1ₒ = 0
Value2ₒ = 0
For each S where offer(S) = o {

Value2ₒ = Value2ₒ + Reach_{S}
For each R for which S has credit {

Value1ₒ= Value1ₒ + credit_{SR}

}

}
rₒ = Value1 / Value2

}

The pseudo code above calculates a subsequent value for the respective time delay parameters (e.g., a and k for the power law distribution, or the respective other parameters if using one of the other time delay distributions). Calculation of the respective time delay parameters is performed by applying the generated response attribution value and the time delay distribution to a regression model (again, regression may apply to power law time delay distribution).

Subsequent values for the respective time delay parameters (e.g., again a and k for the power law time delay distribution, or other parameters as appropriate) are computed based on the marketing channel used in the marketing campaign associated with the stimuli. Subsequent values for the respective time delay parameters are also computed based upon promotion offers and other attributes of a marketing campaign. Whatever factors may affect the response delay distribution may be taken into consideration when determining how many sets of parameters should be computed. Typically, different channels may have different delay characteristics. As such, different time delay parameters may be learned for each channel. For example, email typically has shorter delays than conventional postage/letter carrier services. Other factors that affect response delays may include the type of offer or customer demographics.

For interval stimuli, the delay may be considered as the average delay over the interval (typically at the midpoint). For each channel “c” in a marketing campaign, and for each “S-R” pair where the stimulus is associated with the channel “c” and the stimulus (S) receives some credit for the response (R), “x” and “y” values for a regression may be computed. The “x” value represents the natural logarithm (ln) of the time delay between response (R) and stimulus (S) in the S-R pair. The “y” value represents the natural logarithm (ln) of a complementary cumulative distribution function (“CCDF”). The “y” value equals the probability (“Pr[X>x]”) that a random value time delay (e.g., “X”) is greater than the measured time delay (e.g., “x”) between response (R) and stimulus (S) in a particular S-R pair. The probability that a random value time delay is greater than the time delay between response (R) and stimulus (S) may take into consideration the response attribution value associated with the S-R pair. Additionally, a weight value may be set to equal the response attribution value for the S-R pair. The processing may execute a regression against a vector of “x” values, a vector of “y” values, and a vector of the associated weight values.

For example, in a power law distribution, the log-log plot of Pr[X>x] may approximate a straight line because ln(Pr[X>x])=−α (ln x−ln k). Additionally, numerous power law distributions may be superimposed on each other. By fitting a line to the log-log plot(s) of Pr[X>x], the processing may determine the line's slope and intercept values. The processing may further calculate a subsequent value of the power law parameter (a) based on the slope value of the line. The processing may then calculate a subsequent value of the power law parameter (k) based on the slope and the intercept values of the line.

The following further example pseudo code corresponds to the foregoing processes of calculating the subsequent values of the power law parameters.

for each channel c {

for each SR pair where channel(S) = c and S receives some credit
for R {

Let X_{SR} = ln [delay_{SR}]
Let Y_{SR} = ln [prob [delay > delay_{SR}]], taking into
consideration the weight of each observation
Let weight_{SR} = credit_{SR}

}
Run linear weighted regression on the X's, Y's, and weights,
yielding slope and intercept
α_{c} = −slope
k_{c} = e^{(intercept/-slope)}

}

For the polynomial distribution, the delays may be sorted and the (P+1)^{-th} root of the sorted file depth may be used as the “y” value associated with each “x,” and a linear regression may be performed on these values. If the data fit the distribution, then “L” may be derived from the slope.

For the log normal distribution, the natural logarithm of all the delays (which are assumed to be normally distributed) may be taken. The credit associated with each delay observation may be used as its weight within the sample, and the weighted mean and variance may be computed from the sample. These values may become the updated location and scale parameters of the log normal distribution.

Based on the system's iterative execution of the process 500 through blocks 506, 508, and 510, the accuracy of the values for the response rate and the power law parameters may improve over time, causing an accompanying improvement in the weights (e.g., the credit values, credit_{SR}) assigned to the stimuli, causing an ongoing cycle of improvement.

As described above in association with FIG. 1 through FIG. 5, the example systems and processes provide time interval-based statistically-inferred response attributions. Many other variations and additional activities associated with time interval-based statistically-inferred response attributions are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. The subject matter was described to explain the principles of the invention and the practical application, and to enable others of ordinary skill in the art to understand the invention for various embodiments with various modifications as are suited to the particular use contemplated.

What is claimed is:

1. A computer-implemented method, comprising:
creating, by a processor, a time interval-based stimulus based upon a statistically-inferred time interval-based response rate, where the time interval-based stimulus accounts over time for a proportion of responses that occur without being attributable to other stimuli;
retrieving a response; and
calculating, using the time interval-based stimulus and the response, a time-interval response attribution value, where the time-interval response attribution value is calculated by applying a combination of a first response rate model and a second time delay model that weights output of the first response rate model based upon a continuous range of time delays between a minimum and maximum difference in time that separate the time interval-based stimulus and the response.

2. The computer-implemented method of claim 1, where:
the statistically-inferred time interval-based response rate comprises a statistically-inferred time-based threshold response rate; and
creating, by the processor, the time interval-based stimulus based upon the statistically-inferred time interval-based response rate comprises:
creating, based upon the statistically-inferred time-based threshold response rate, a threshold stimulus that accounts over time for responses that occur without being caused by other preceding stimuli.

3. The computer-implemented method of claim 1, where:
the statistically-inferred time interval-based response rate comprises a statistically-inferred time marketing-range response rate; and
creating, by the processor, the time interval-based stimulus based upon the statistically-inferred time interval-based response rate comprises:
creating, based upon the statistically-inferred time marketing-range response rate, a marketing-range stimulus that accounts over time for responses that occur for which at least one of a confirmed contact and a confirmed time of contact is unknown.

4. The computer-implemented method of claim 1, where calculating, using the time interval-based stimulus and the response, the time-interval response attribution value comprises:
calculating, using the time interval-based stimulus and the response, the time-interval response attribution value during a training iteration of response rate parameter calculations, where the time-interval response attribution value is calculated by applying a combination of the first response rate model, the second time delay model, and a reach probability value that specifies the likelihood that a stimulus was actually received.

5. The computer-implemented method of claim 1, further comprising:
retrieving a plurality of actual contact stimuli; and
calculating one of a plurality of additional time-interval response attribution values for each one of the retrieved plurality of actual contact stimuli paired with the response.

6. The computer-implemented method of claim 5, further comprising:
normalizing the time-interval response attribution value with each of a plurality of additional time-interval response attribution values; and
computing a normalized time-interval response attribution value for each of the time interval-based stimulus and the plurality of actual contact stimuli.

7. The computer-implemented method of claim 1, where:
the time interval-based stimulus comprises a mass media stimulus, and the response comprises an inferred response; and
calculating, using the time interval-based stimulus and the response, the time-interval response attribution value comprises:
calculating, using the time interval-based stimulus and the response, the time-interval response attribution value by applying a combination of the first response rate model, the second time delay model, and a third reach probability model that estimates a likelihood that the mass media stimulus actually reached a customer associated with the inferred response.
